(19) United States
(12) Patent Application Publication
(10) Pub. No.: US 2017/0206091 A1
(43) Pub. Date: Jul. 20, 2017

(54) SHARING OWNERSHIP OF AN INPUT/OUTPUT DEVICE WITH AN EXISTING PARTITION

(71) Applicant: International Business Machines Corporation, Armonk, NY (US)

(72) Inventors: Juan J. ALVAREZ, Rochester, MN (US); Jesse P. ARROYO, Rochester, MN (US); Paul G. CRUMLEY, Yorktown Heights, NY (US); Charles S. GRAHAM, Rochester, MN (US); Joefon JANN, Ossining, NY (US); Timothy J. SCHIMKE, Stewartville, MN (US); Ching-Farn E. WU, Yorktown Heights, NY (US)

(21) Appl. No.: 15/001,743

(22) Filed: Jan. 20, 2016

(51) Int. Cl. G06F 9/44; G06F 9/455; G06F 13/10

(52) U.S. Cl. CPC G06F 9/4411; G06F 13/102; G06F 9/45558; G06F 2009/45579; G06F 2009/4557

(57) ABSTRACT

The present disclosure relates to sharing an I/O device across multiple virtual machines. According to one embodiment, a computing system establishes a communication channel between a first partition and a second partition. The first partition generally owns an I/O device and the second partition hosts a device driver for the I/O device. The computing system configures shared ownership of the I/O device between the first partition and one or more virtual machines and transfers partial ownership of the I/O device to the second partition. Device configuration information is generated for the I/O device, which is used by the one or more virtual machines and the second partition to access and configure the I/O device. Subsequently, the computing system boots the one or more virtual machines.

### BACKGROUND

The present invention relates to sharing a physical device in a computing system, and more specifically to sharing a physical device across multiple virtual machines (e.g., logical partitions [LPARs]).

In paravirtualized environments, multiple virtual machines (e.g., LPARs) may use the same physical I/O device, such as a network adapter. The hypervisor may isolate virtual machines, allowing a single virtual machine to access the physical I/O device at a time. To allow each virtual machine to use the same physical I/O device, the hypervisor may present a virtual device to each virtual machine. When a virtual machine performs I/O operations on the virtual device, the hypervisor can intercept (and queue) I/O requests by the virtual machine and pass the requested commands to the physical I/O device. Generally, the hypervisor may have full ownership of the physical I/O device, and the virtual machines may not be able to directly access the physical I/O device or perform error recovery operations on the physical I/O device.

In some virtualized environments, a physical I/O device may allow multiple virtual machines to use the device concurrently through single root I/O virtualization (SR-IOV). In SR-IOV, a physical device may have physical functions (PFs) that allow for input/output and device configuration, as well as one or more virtual functions (VFs) that allow for data input/output. For example, an n-port network adapter may expose m VFs (e.g., one or more VFs for each port) that may be used by the virtual machines hosted on a computing system. A hypervisor on the host computing system may interact with the physical I/O device using the PFs, while each can directly communicate with a portion of the physical I/O device using one or more VFs.

If VMs communicate and use physical I/O devices through a hypervisor, performance may be negatively impacted due to additional processing required at the hypervisor to move data and commands from the physical I/O device to the appropriate VM. In a virtualized environment where VMs use VFs exposed by an I/O device that supports SR-IOV, VMs may not be able to use all of the features supported by the I/O device.

### SUMMARY

One embodiment disclosed herein includes a method for sharing an I/O device across a plurality of virtual machines. The method generally includes establishing a communication channel between a first partition and a second partition. The first partition generally owns an I/O device and the second partition hosts a device driver for the I/O device. The computing system configures shared ownership of the I/O device between the first partition and one or more virtual machines and transfers partial ownership of the I/O device to the second partition. Device configuration information is generated for the I/O device, which is used by the one or more virtual machines and the second partition to access and configure the I/O device. Subsequently, the computing system boots the one or more virtual machines.

Another embodiment includes a computer-readable storage medium having instructions, which, when executed on a processor, performs an operation for sharing an I/O device across a plurality of virtual machines. The operations generally include establishing a communication channel between a first partition and a second partition. The first partition generally owns an I/O device and the second partition hosts a device driver for the I/O device. The computing system configures shared ownership of the I/O device between the first partition and one or more virtual machines and transfers partial ownership of the I/O device to the second partition. Device configuration information is generated for the I/O device, which is used by the one or more virtual machines and the second partition to access and configure the I/O device. Subsequently, the computing system boots the one or more virtual machines.

Still another embodiment includes a processor and a memory storing a program, which, when executed on the processor, performs an operation for sharing an I/O device across a plurality of virtual machines. The operations generally include establishing a communication channel between a first partition and a second partition. The first partition generally owns an I/O device and the second partition hosts a device driver for the I/O device. The computing system configures shared ownership of the I/O device between the first partition and one or more virtual machines and transfers partial ownership of the I/O device to the second partition. Device configuration information is generated for the I/O device, which is used by the one or more virtual machines and the second partition to access and configure the I/O device. Subsequently, the computing system boots the one or more virtual machines.

### BRIEF DESCRIPTION OF THE SEVERAL VIEWS OF THE DRAWINGS

FIG. 1 illustrates an example system architecture in which one or more virtual machines share ownership of and interface directly with an I/O device, according to one embodiment.

FIG. 2 illustrates example operations that may be performed by a computing system to establish shared I/O device ownership between a device owner and one or more virtual machines through a dedicated device driver partition, according to one embodiment.

FIG. 3 illustrates example operations that may be performed by a computing system to revoke shared ownership of an I/O device from one or more virtual machines, according to one embodiment.

FIG. 4 illustrates example operations that may be performed by a computing system to perform error recovery or maintenance operations on an I/O device and reestablish shared ownership of the I/O device with one or more virtual machines, according to one embodiment.

FIG. 5 illustrates an example system in which multiple virtual machines share ownership of an I/O device and interface directly with the I/O device, according to one embodiment.

### DETAILED DESCRIPTION

Embodiments presented herein describe techniques for sharing ownership of a physical I/O device across multiple virtual machines. By sharing ownership of a physical I/O device across multiple virtual machines, a virtual machine can directly interface with the physical I/O device and fully use the capabilities of the physical I/O device. The virtual machines can bypass communicating with the physical I/O device through a hypervisor, which may improve I/O device performance for the virtual machines. Additionally, by sharing ownership of a physical I/O device across multiple virtual machines, the virtual machines may use the same functionality of the same physical I/O device concurrently.

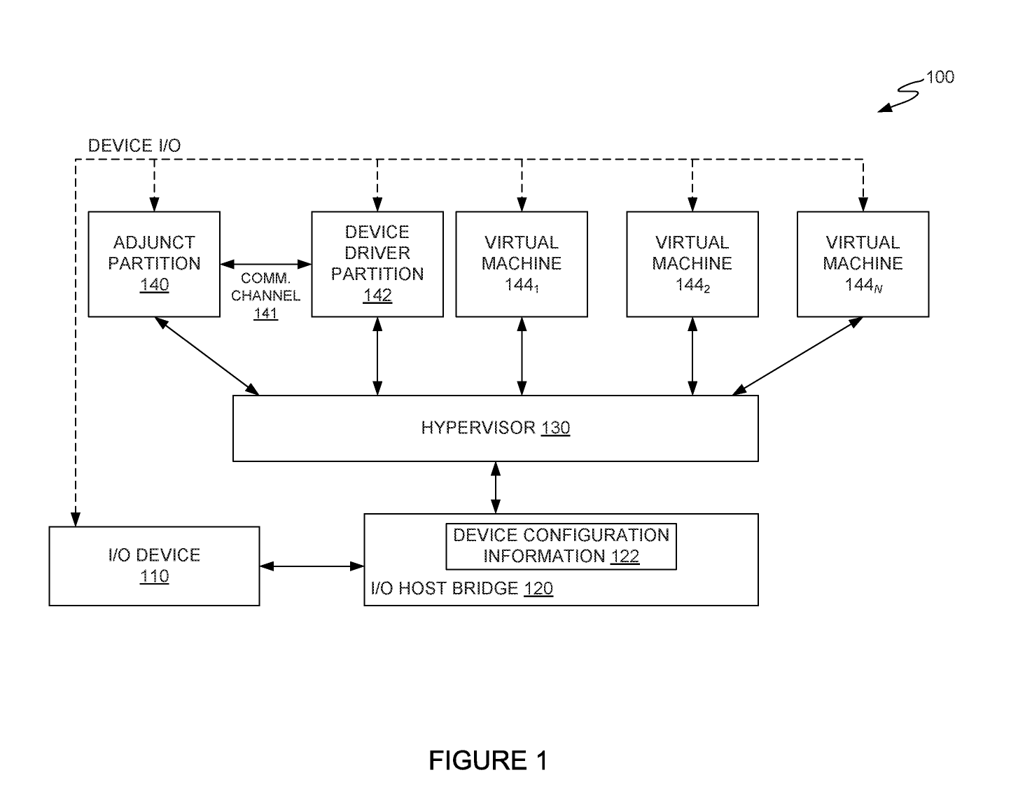

FIG. 1 illustrates an example architecture of a system in which one or more virtual machines share ownership of an I/O device, according to one embodiment. As illustrated, computing system 100 includes an I/O device 110, an I/O host bridge 120, hypervisor 130, adjunct partition 140, a device driver partition 142, and one or more virtual machines 144.

I/O device 110 can provide a variety of services and/or functionality to an operating system operating as a host on computing system 100 or one or more virtual machines 144. For example, I/O device 110 may provide network connectivity functions to computing system 100, coprocessor functionality (e.g., graphics processing, encryption/decryption, database processing, etc.). I/O device 110 may interface with other components in computing system 100 via, for example, a PCI Express bus. In some cases, I/O device 110 may denote a single adapter function, but need not be the entire physical I/O adapter.

I/O device 110 may expose one or more physical functions to a host operating system (or hypervisor 130) and one or more virtual machines 144 having shared ownership of I/O device 110 (e.g., through device driver partition 142).

I/O host bridge 120 generally provides an interface between one or more central processing units (CPUs) and I/O device 110 and allows a host operating system (or hypervisor) to configure I/O device 110. As illustrated, I/O host bridge 120 maintains configuration information 122 for I/O device 110. Configuration information 122 includes, for example, configuration addresses, memory mapped I/O (MMIO) memory space information, direct memory access space information, and I/O device interrupt information for I/O device 110. When computing system 100 operates (e.g., at boot time or when a new I/O device 110 has been added to computing system 100), computing system 100 may create an assignable I/O unit (e.g., partitionable endpoint) that identifies I/O device 110, the functionality exposed by I/O device 110 (e.g., a physical function), and the memory and interrupt addresses to be used by computing system 100 (and/or virtual machines 144 hosted on computing system 100).

Hypervisor 130 generally provides operating system functionality (e.g., process creation and control, file system process threads, etc.) as well as CPU scheduling and memory management for one or more virtual machines 144 managed by hypervisor 130. While computing system 100 operates, hypervisor 130 generally interfaces with adjunct partition 140 and I/O host bridge 120 to establish shared ownership of an I/O device 110 between a device driver partition 142 and one or more virtual machines 144.

Adjunct partition 140 generally acts as the primary owner of an I/O device 110 and a central point of management for the I/O device (e.g., for error recovery operations). At boot (or initialization) time, adjunct partition 140 has full ownership of and access to I/O device 110. To set up I/O device 110 for shared ownership by one or more virtual machines 144 operating on computing system 100, hypervisor 130 sets an internal flag to indicate that I/O device 110 is owned by adjunct partition 140. In some cases, adjunct partition 140 may be a lightweight, hidden partition that hosts device drivers and provides other services to one or more virtual machines 144 hosted on computing system 100, but need not host an operating system or external-facing functionality.

Hypervisor 130 proceeds to set device configuration information 122 at host bridge 120 with information about I/O device 110. By setting device configuration information 122, hypervisor 130 defines a partitionable endpoint, which may include, as discussed above, configuration addresses, memory mapped I/O memory spaces, direct memory access spaces, and interrupt information. The interrupt information may include, for example, an interrupt number (or range) as well as information about the owner of the I/O device (e.g., adjunct partition 140).

After hypervisor 130 configures I/O device 110 at I/O host bridge 120, adjunct partition 140 may learn that device driver partition 142 exists. Adjunct partition 140 may learn about device driver partition 142 from a management entity. The management entity may be located, for example, at hypervisor 130, device driver partition 142, another virtual machine hosted on computing system 100, or an external device in communication with computing system 100. After notifying adjunct partition 140 that device driver 142 exists, the management entity may establish a communication channel 141 between adjunct partition 140 and device driver partition 142. Communication channel 141 may be used to communicate device status and other information between adjunct partition 140 and device driver partition 142, as discussed in further detail below.

After hypervisor 130 configures I/O device 110 at I/O host bridge 120 and the communication channel 141 is established between adjunct partition 140 and device driver 142, hypervisor 130 may receive a command from adjunct partition 140 to transfer partial ownership of I/O device 110 to device driver partition 142. In some cases, device driver partition 142 may be a virtual machine hosting a guest operating system and device drivers for one or more I/O devices 110 which allow device driver partition 142 and one or more virtual machines 144 to use the functionality of the one or more I/O devices 110. Device driver partition 142, for example, may be implemented in an existing virtual machine in computing system 100.

Adjunct partition 140 subsequently notifies device driver partition 142, via communication channel 141, that I/O device 110 has been shared. Adjunct partition 140 additionally transmits identifying information for I/O device 110 to device driver partition 142, which device driver partition 142 (and virtual machines 144 obtaining drivers for I/O device 110 from device driver partition 142) uses to perform discovery operations for I/O device 110.

Upon receiving the command to transfer partial ownership of the I/O device 110 to device driver partition 142, hypervisor 130 sets the internal flag to indicate that ownership of I/O device 110 is shared between adjunct partition 140 and device driver partition 142. Hypervisor 130 additionally configures I/O host bridge to reassign resources to device driver partition 142 (and one or more virtual machines 144 that obtain drivers for I/O device from device driver partition 142). For example, hypervisor 130 can reassign a number of interrupts (e.g., message signaled interrupts and/or level signaled interrupts) to device driver partition 142 (and the one or more virtual machines 144 that obtain drivers for I/O device 110 from device driver partition 142). Hypervisor 130 may additionally reassign certain MIMIO address spaces, direct memory access spaces, and configuration spaces, and so on to device driver partition 142.

In preparation for booting one or more virtual machines 144 with access to I/O device 110, device driver partition 142 requests information about I/O device 110 from hypervisor 130. The request may include, for example, the identifying information for I/O device 110 received from adjunct partition 140. In response, hypervisor 130 generates information that virtual machines 144 may use to discover and access I/O device 110. For example, hypervisor 130 may establish or populate an existing device tree or table including information about I/O device 110. When virtual machine 144 is booted, virtual machine 144 uses the device tree or table to discover and access I/O device 110. In some embodiments, the data in a device tree or table established and populated by hypervisor 130 may be substantially similar to a device tree or table used in a non-virtualized environment, which allows virtual machine 144 to host a substantially unmodified operating system kernel. Subsequently, hypervisor 130 may boot virtual machine 144, which reads the device tree or table, discovers I/O device 110, and configures I/O device 110 on boot.

In some cases, adjunct partition 140 (which, as discussed above, initially has full ownership of I/O device 110) may access and configure I/O device 110 using an I/O device configuration cycle. To configure I/O device 110, adjunct partition 140 indicates to hypervisor 130 that adjunct partition 140 is attempting to access the configuration space of I/O device 110. Hypervisor 130 examines the identity of the adjunct partition and ownership information associated with I/O device 110. If adjunct partition 140 is identified in the ownership information as an owner authorized to access the configuration space, hypervisor 130 sequences configuration requests from the adjunct partition 140 with configuration requests received from virtual machines 144₁-144_{N}. When hypervisor 130 executes the configuration request from the adjunct partition 140, hypervisor 130 transmits the configuration request to I/O host bridge 120 for processing. Upon completion, hypervisor 130 returns a result to adjunct partition 140 indicating whether or not the requested configuration was successful.

During operations on computing system 100, adjunct partition 140 can determine that shared ownership of I/O device 110 is to be revoked from device driver partition 142 and the virtual machines 144 that have obtained access to I/O device 110 through the device driver hosted on device driver partition 142. For example, adjunct partition 140 can determine that shared ownership of I/O device 110 is to be revoked for I/O device maintenance or recovery, such as when I/O device 110 encounters a fatal error that may require a hard reset or replacement of I/O device 110. To revoke shared ownership of I/O device 110 from device driver partition 142 and the one or more virtual machines 144 that have obtained access to I/O device 110 through the device driver hosted on device driver partition 142, adjunct partition 140 transmits a command to hypervisor 130 to freeze activity at I/O device 110. When hypervisor 130 freezes activity at I/O device 110, any write operations on I/O device performed by adjunct partition 140, device driver partition 142, and the one or more virtual machines 144 will be dropped, and any read operations on I/O device will return an invalid value.

Once I/O device is frozen, adjunct partition 140 transmits a message to device driver partition 142, via communication channel 141, indicating that I/O device 110 is to be removed from device driver partition 142. On receipt of this message from adjunct partition 140, device driver partition 142 halts the driver for I/O device 110 and unloads the device driver. After device driver partition halts and unloads the driver for I/O device 110, adjunct partition requests that hypervisor 130 revoke shared ownership of I/O device 110 from device driver partition 142, as well as any virtual machines 144 that have obtained access to I/O device 110 through the device driver hosted on device driver partition 142. To revoke shared ownership of I/O device 110, hypervisor 130 configures I/O host bridge 120 to reassign resources previously assigned (or shared with) device driver partition 142 to adjunct partition 140. These resources may include, for example, I/O device interrupts, address spaces (e.g., memory mapped I/O and/or direct memory access spaces), and I/O device configuration spaces. Additionally, hypervisor 130 sets the internal flag used to track shared ownership of I/O device 110 to a value indicating that I/O device 110 is owned solely by adjunct partition 140.

Upon reassigning I/O device resources to adjunct partition 140, hypervisor 130 and/or adjunct partition 140 may allow a user to hot-swap I/O device 110 for a replacement I/O device. Once the replacement I/O device is hot-swapped into computing system 100, adjunct partition 140 configures the I/O device and transfers ownership of the replacement I/O device to device driver partition 142, as discussed above. Subsequently, one or more virtual machines 144 may obtain the device driver from device driver partition 142 and perform I/O operations on the replacement I/O device.

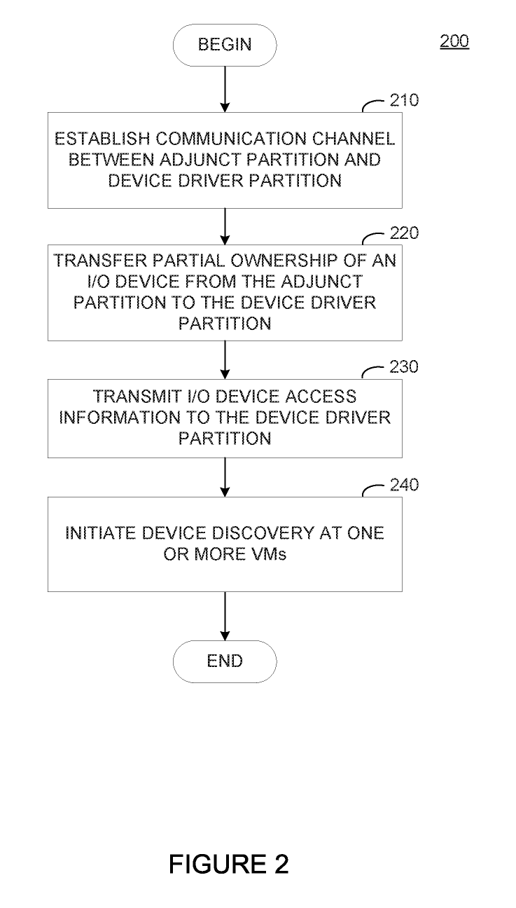

FIG. 2 illustrates example operations 200 that may be performed by a computing system to share ownership of I/O device 110 between an adjunct partition and a device driver partition from which one or more virtual machines obtain a driver for I/O device 110, according to one embodiment. As illustrated, operations 200 begin at step 210, where the computing system establishes a communication channel between an adjunct partition and a device driver partition. As discussed above, the adjunct partition may be the initial (and primary) owner of an I/O device, and the device driver partition may host drivers for the I/O device that are used by one or more virtual machines to obtain access to the I/O device.

At step 220, the computing system transfers partial ownership of an I/O device from the adjunct partition to the device driver partition. As discussed above, transferring partial ownership of an I/O device may include, for example, reassigning I/O device resources (e.g., interrupt ranges, memory mapped I/O and/or direct memory access spaces, configuration addresses, and so on) from the adjunct partition to the device driver partition. Additionally, a hypervisor may set internal flags to indicate a change from sole ownership of an I/O device by, for example, an adjunct partition to shared ownership of the I/O device between at least the adjunct partition and the device driver partition.

At step 230, the computing system transmits I/O device access information to the device driver partition. For example, the adjunct partition may transmit the I/O device access information, which may include basic identifying information about the I/O device, to the device driver partition via the communications channel established between the adjunct partition and device driver partition. At step 240, the computing system initiates device discovery at one or more virtual machines. Device discovery generally begins with a virtual machine requesting device information from a hypervisor. In response, a virtual machine receives information such as a device tree or table that includes, for example, the interrupt ranges, memory spaces, and configuration spaces assigned to the device driver partition. The virtual machine uses the information to find a particular I/O device and configure the I/O device for later use.

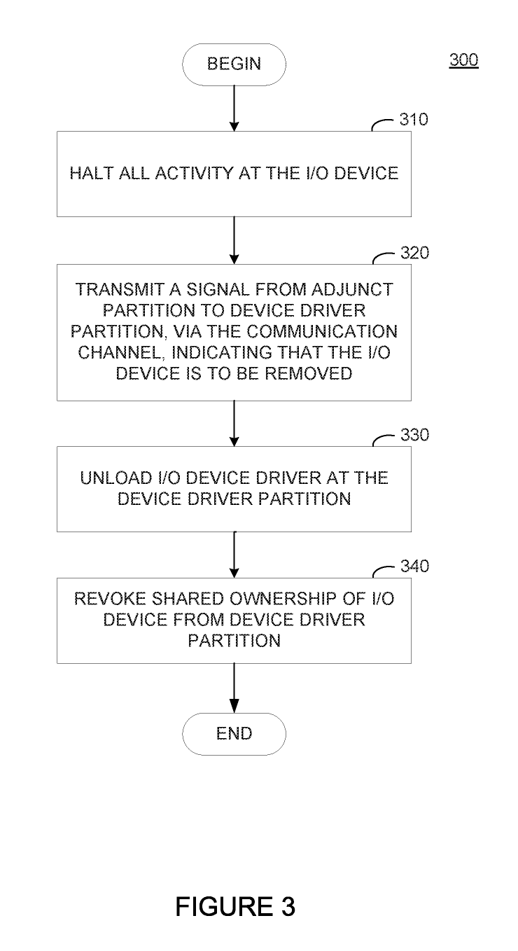

FIG. 3 illustrates example operations 300 that may be performed by a computing system to revoke shared ownership of an I/O device, according to one embodiment. As illustrated, operations 300 begin at step 310, where the computing system halts all I/O activity at the I/O device. As described above, a computing system can halt I/O activity at an I/O device by freezing the I/O device, which causes the I/O host bridge to drop write requests to the I/O device and return a preset value in response read requests from a device owner.

At step 320, the computing system transmits a signal from the adjunct partition to the device driver partition indicating that the I/O device is to be removed. As discussed above, the signal may be transmitted from the adjunct partition to the device driver partition via the communication channel established between the adjunct partition and the device driver partition. The signal may include, for example, information identifying a particular I/O device to be removed from the device driver partition. Upon receiving the signal, at step 330, the device driver partition unloads the I/O device driver.

At step 340, the computing system revokes the shared ownership of the I/O device from the device driver partition. As discussed above, to revoke shared ownership of the I/O device from the device driver partition, the adjunct partition can request that the hypervisor revoke the shared ownership. In response, the hypervisor configures the I/O host bridge to reassign I/O device resources (e.g., interrupt space, memory spaces, configuration spaces, and so on) to the adjunct partition. Additionally, the hypervisor can reset internal flags used to track ownership of an I/O device to indicate that ownership of the I/O device has transitioned from shared ownership between the adjunct partition and the device partition to sole ownership by the adjunct partition.

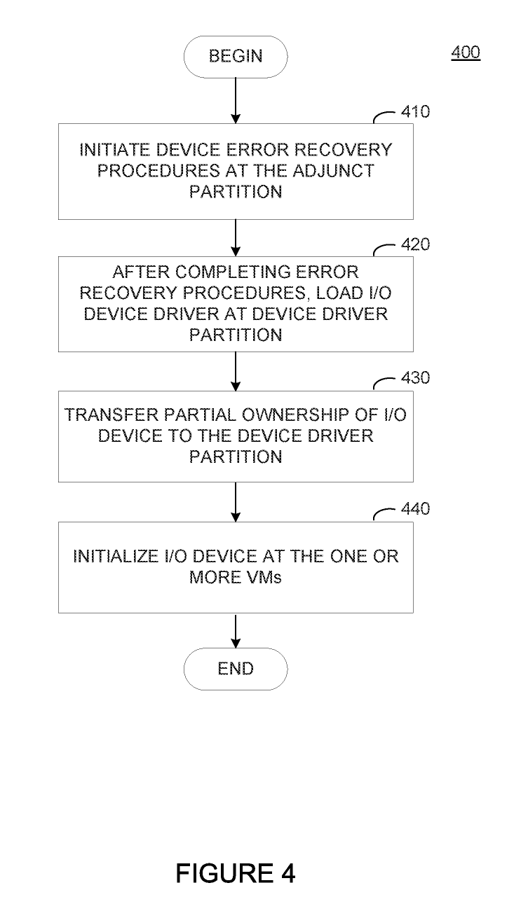

FIG. 4 illustrates example operations 400 that may be performed by a computing system to initiate error recovery operations for an I/O device, according to one embodiment. As illustrated, operations 400 begin at step 410, where the computing system initiates device error recovery procedures at the adjunct partition. In some cases, where the I/O device encounters a fatal error that cannot be addressed through a soft reset of the I/O device, the computing system may enable hot-swap capabilities for the I/O device connection. While the computing system is running, a user can perform a hard reset of an I/O device or replace the I/O device.

At step 420, after completing error recovery procedures, the computing system loads the I/O device driver at the device driver partition. In loading the device driver into the device driver partition, the computing system sets up the device driver partition for sharing the device driver with one or more virtual machines, as discussed herein.

At step 430, the computing system transfers partial ownership of the I/O device (e.g., the replacement I/O device) to the device driver partition. As discussed above, transferring partial ownership of the I/O device to the device driver partition may include, for example, adjusting the I/O device configuration to reflect that I/O resources solely owned by an adjunct partition are now jointly owned by the adjunct partition and the device driver partition. Additionally, transferring partial ownership may include adjusting one or more flag variables in a hypervisor to indicate that an I/O device is no longer owned by a single user.

At step 440, the computing system initializes the I/O device at the one or more VMs. As discussed above, before booting a VM, the hypervisor can log addressing information for the I/O device and transmit the data to one or more virtual machines. The data may be transmitted to the device driver partition and/or other device partition, and the virtual machines may request information about a specific I/O device. Using the logged addressing data, the one or more virtual machines can establish shared ownership of an I/O device and the ability to use an I/O device that may have been previously subject to I/O recovery operations.

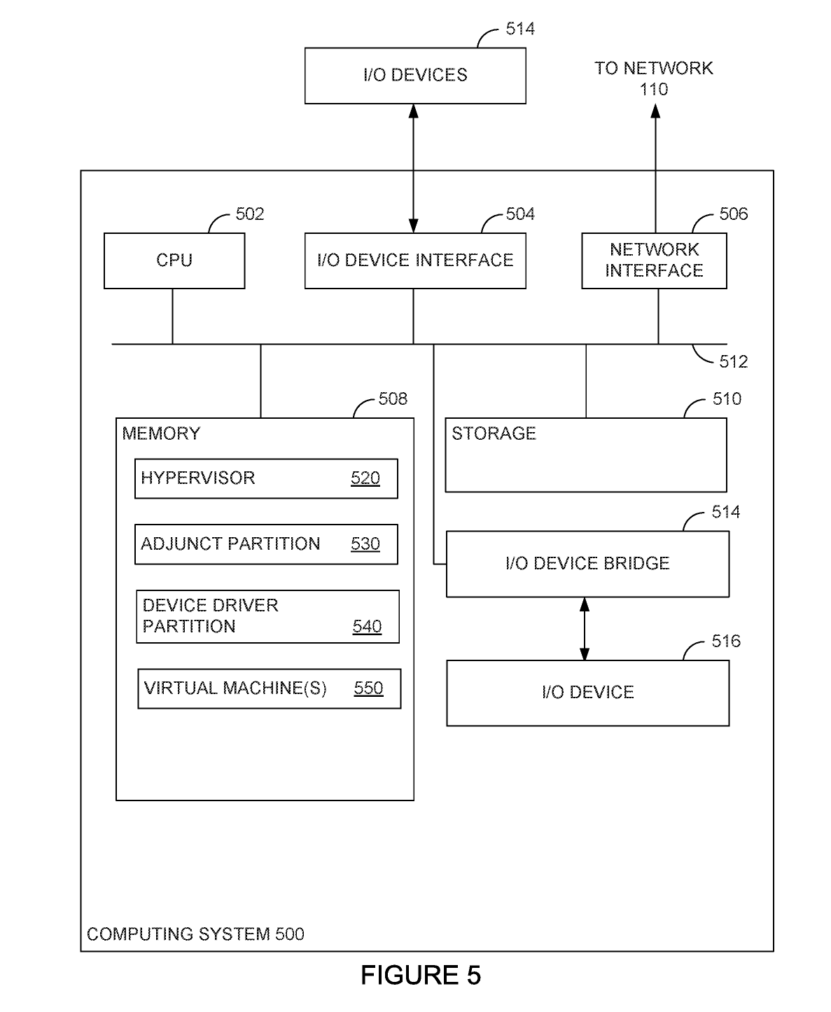

FIG. 5 illustrates an example computing system 500 that shares a single coprocessor hardware context among multiple related processes, according to an embodiment. As shown, the server includes, without limitation, a central processing unit 502, one or more I/O device interfaces 504, which may allow for the connection of various I/O devices 514 (e.g., keyboards, displays, mouse devices, pen input, etc.) to the computing system 500, network interface 506, a memory 508, storage 510, coprocessor interface 514, coprocessor 516, and an interconnect 512.

CPU 502 may retrieve and execute programming instructions stored in the memory 508. Similarly, the CPU 502 may retrieve and store application residing in the memory 508. The interconnect 512 transmits programming instructions and application data among the CPU 502, I/O device interface 504, network interface 506, memory 508, and storage 510. CPU 502 is included to be representative of a single CPU, multiple CPUs, a single CPU having multiple processing cores, and the like. Additionally, the memory 508 is included to be representative of a random access memory. Furthermore, the storage 510 may be a disk drive. Although shown as a single unit, the storage 510 may be a combination of fixed and/or removable storage devices, such as fixed disc drives, removable memory cards or optical storage, network attached storage (NAS), or a storage area-network (SAN).

I/O device bridge 514 generally allows one or more I/O devices 516 installed in computing system 500 to communicate with CPU 502 and access memory space(s) in memory 508. As discussed above, I/O host bridge may include device configuration information that is set by a hypervisor 520 when I/O device 516 is configured and is used by one or more virtual machines 540 to find and configure I/O device 516. While computing system 500 operates, I/O host bridge 514 may detect errors at I/O device 516 and raise these errors to a hypervisor 520 in memory 508 for further processing.

As shown, memory 508 includes a hypervisor 520, adjunct partition 530 and one or more virtual machines 540. As discussed above, hypervisor 520 may generally be used to manage I/O functionality for the adjunct partition and the one or more virtual machines hosted on computing system 500. When computing system 500 is booted up or when a new I/O device 516 is added to computing system 500, hypervisor 520 generally configures the resources used by the I/O device and propagates shared ownership of the I/O device to the one or more virtual machines 540 hosted on computing system 500. As described above, adjunct partition 530 may be a hidden partition and may interact with I/O device bridge 514 to obtain information from I/O device 516, perform initial error recovery on I/O device 516, and indicate to hypervisor 520 whether or not the device driver partition 540 and virtual machines 550 can perform operations using I/O device 516. For example, during error recovery operations, adjunct partition 530 can inform hypervisor 520 that the adjunct partition is currently performing error recovery operations that may require the one or more virtual machines 550 to freeze I/O activity on I/O device 516. As discussed above, if the error is a fatal error requiring more substantial configuration or replacement of the I/O device, adjunct partition 530 can inform hypervisor 520 that a fatal error has occurred, upon which hypervisor 520 can revoke shared ownership of the I/O device from the device driver partition 540 until the fatal error is corrected.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the entity analytics system) or related data available in the cloud. For example, the entity analytics system could execute on a computing system in the cloud and determine relationships between different entities stored in the entity analytics system, for example, based on determining relationships between sub-entities. In such a case, the entity analytics system could receive an input specifying parameters for the entity analytics system to search for and determine relationships between entities and store information about the determined relationships at a storage location in the cloud. Doing so allows a user to access this information from any computing system attached to a network connected to the cloud (e.g., the Internet).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for sharing an I/O device across a plurality of virtual machines, comprising:
establishing a communication channel between a first partition and a second partition, wherein the first partition owns an I/O device and the second partition hosts a device driver for the I/O device;
configuring shared ownership of the I/O device between the first partition and one or more virtual machines;
transferring partial ownership of the I/O device to the second partition;
generating device configuration information for the I/O device to be used by the one or more virtual machines and the second partition to access and configure the I/O device; and
booting the one or more virtual machines.

2. The method of claim 1, wherein booting the one or more virtual machines comprises:
loading, at a first virtual machine, the device driver from the second partition;
requesting device information for the I/O device, and
based on the device information, configuring the I/O device on the first virtual machine.

3. The method of claim 1, further comprising:
determining that ownership of the I/O device is to be revoked from each of the one or more virtual machines;
terminating I/O device operations at the one or more virtual machines; and
reconfiguring the I/O device to reallocate ownership of the I/O device to the first partition and revoke partial ownership from the one or more virtual machines.

4. The method of claim 3, wherein determining that ownership of the I/O device is to be revoked from the one or more virtual machines comprises detecting a fatal error at the I/O device.

5. The method of claim 3, wherein terminating I/O device operations at the one or more virtual machines comprises unloading the device driver at the one or more virtual machines.

6. The method of claim 3, further comprising:
upon replacement of the I/O device with a second I/O device, configuring the second I/O device and granting full ownership of the second I/O device to the first partition.

7. The method of claim 6, further comprising:
configuring shared ownership of the second I/O device between the first partition and the one or more virtual machines.

8. A computer program product, comprising:
a computer-readable storage medium having computer readable program code embodied therewith, the computer readable program code configured to perform an operation for sharing an I/O device across a plurality of virtual machines, the operation comprising:
establishing a communication channel between a first partition and a second partition, wherein the first partition owns an I/O device and the second partition hosts a device driver for the I/O device;
configuring shared ownership of the I/O device between the first partition and one or more virtual machines;
transferring partial ownership of the I/O device to the second partition;
generating device configuration information for the I/O device to be used by the one or more virtual machines and the second partition to access and configure the I/O device; and
booting the one or more virtual machines.

9. The computer program product of claim 8, wherein booting the one or more virtual machines comprises:
loading, at a first virtual machine, the device driver from the second partition;
requesting device information for the I/O device, and
based on the device information, configuring the I/O device on the first virtual machine.

10. The computer program product of claim 8, wherein the operations further comprise:
determining that ownership of the I/O device is to be revoked from each of the one or more virtual machines;
terminating I/O device operations at the one or more virtual machines; and
reconfiguring the I/O device to reallocate ownership of the I/O device to the first partition and revoke partial ownership from the one or more virtual machines.

11. The computer program product of claim 10, wherein determining that ownership of the I/O device is to be revoked from the one or more virtual machines comprises detecting a fatal error at the I/O device.

12. The computer program product of claim 10, wherein terminating I/O device operations at the one or more virtual machines comprises unloading the device driver at the one or more virtual machines.

13. The computer program product of claim 10, wherein the operations further comprise:
upon replacement of the I/O device with a second I/O device, configuring the second I/O device and granting full ownership of the second I/O device to the first partition.

14. The computer program product of claim 13, wherein the operations further comprise:
configuring shared ownership of the second I/O device between the first partition and the one or more virtual machines.

15. A system, comprising:
a processor; and
a memory storing one or more instructions which, when executed by the processor, performs an operation for sharing an I/O device across a plurality of virtual machines, the operation comprising:
establishing a communication channel between a first partition and a second partition, wherein the first partition owns an I/O device and the second partition hosts a device driver for the I/O device;
configuring shared ownership of the I/O device between the first partition and one or more virtual machines;
transferring partial ownership of the I/O device to the second partition;
generating device configuration information for the I/O device to be used by the one or more virtual machines and the second partition to access and configure the I/O device; and
booting the one or more virtual machines.

16. The system of claim 15, wherein booting the one or more virtual machines comprises:
loading, at a first virtual machine, the device driver from the second partition;
requesting device information for the I/O device, and
based on the device information, configuring the I/O device on the first virtual machine.

17. The system of claim 15, wherein the operations further comprise:
determining that ownership of the I/O device is to be revoked from each of the one or more virtual machines;
terminating I/O device operations at the one or more virtual machines; and
reconfiguring the I/O device to reallocate ownership of the I/O device to the first partition and revoke partial ownership from the one or more virtual machines.

18. The system of claim 17, wherein terminating I/O device operations at the one or more virtual machines comprises unloading the device driver at the one or more virtual machines.

19. The system of claim 17, wherein the operations further comprise:
upon replacement of the I/O device with a second I/O device, configuring the second I/O device and granting full ownership of the second I/O device to the first partition.

20. The system of claim 19, wherein the operations further comprise:
configuring shared ownership of the second I/O device between the first partition and the one or more virtual machines.
